(19) United States
(12) Patent Application Publication
(10) Pub. No.: US 2007/0138893 A1
(43) Pub. Date: Jun. 21, 2007

(54) Rotor assembly for use in line start permanent magnet synchronous motor

(75) Inventor: Sung Gon Son, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS Corporation, Seoul (KR)

(21) Appl. No.: 11/641,690

(22) Filed: Dec. 20, 2006

(30) Foreign Application Priority Data
Dec. 21, 2005 (KR) 10-2005-0126851

(51) Int. Cl. H02K 21/12; H02K 1/27

(52) U.S. Cl. 310/156.83; 310/156.78

(57) ABSTRACT

A rotor includes a rotor core which has a central portion and a circumferential portion, wherein a shaft hole is formed at the central portion, a plurality of conductor mounting holes are formed along the circumferential portion, a plurality of conductors are inserted into the conductor mounting holes, respectively, and a multiplicity of magnet mounting holes are arranged around the shaft hole along at least one radial direction from the shaft hole; and at least one permanent magnet selectively mounted into at least one corresponding magnet mounting hole.

### FIELD OF THE INVENTION

The present invention relates to a rotor for use in a line start permanent magnet (LSPM) synchronous motor; and, more particularly, to a rotor for use in an LSPM synchronous motor capable of easily controlling features such as rotational speeds, torques, etc. by allowing a distance between a permanent magnet and a conductor to be controlled without changing a rotor core specification.

### FIELD OF THE INVENTION

Generally, a motor is an apparatus that converts electric energy into mechanical energy to obtain rotational power and it may be generally used for industrial equipments as well as household appliances. The motor is largely classified into an alternating current (AC) motor and a direct current (DC) motor.

Meanwhile, an LSPM synchronous motor, i.e., a kind of AC motor, is driven with a torque generated by an interaction between a secondary current generated by a voltage induced onto conductors in a rotor and a magnetic flux generated by a winding wire of a stator. At this time, the torque is initiated by a composition torque of a reluctance torque and/or a magnetic torque and a torque component due to a cage. Also, during a normal operation after the startup, the magnetic flux of the permanent magnet installed in the rotor is synchronous with the magnetic flux generated from the stator so that the LSPM synchronous motor is driven in accordance with a speed of a rotational magnetic field in the stator.

A conventional LSPM synchronous motor according to the prior art will now be described with reference to the accompanying drawings.

FIG. 1 is a plan view illustrating primary portions of the conventional LSPM synchronous motor. As shown in FIG. 1, a conventional LSPM synchronous motor 10 includes a stator 11 fixed to a casing or a shell (not shown), a coil 12 wounded to the stator 11, and a rotor 13 installed in the stator 11 with a gap therebetween to be freely movable within the stator 11.

The stator 11 is formed by laminating a plurality of silicon steel plates of same shape in an axial direction. A hole (not shown) for inserting the rotor 13 therethrough is formed within the stator 11, and a plurality of teeth 11a are formed along an inner surface of the stator 11 so that every two adjacent teeth 11a may be equidistantly apart from each other, thereby forming a slot 11b between every two adjacent teeth 11.

The coil 12 is wound around each tooth 11a, so that the structure of the stator 11 may cause a rotational magnetic flux to be generated when an AC electric power is supplied to the coil 12.

The rotor 13 is rotatably mounted to a central portion of the stator 11 with a gap formed between the rotor 13 and the stator 11. A shaft 13a runs through and is fixed to an inserting hole (not shown) formed to a central portion of the rotor 13. A plurality of conductors 13b are vertically inserted into and fixed along a circumferential portion of the rotor 13, each conductor 13b being shaped as a bar. A multiplicity of magnet mounting holes 13c are formed around the shaft 13a, and a permanent magnet 13d is inserted into and fixed to each magnet mounting hole 13c.

The shaft 13a is mounted to a casing or a shell for forming a case of the LSPM synchronous motor 10, so that the shaft 13a may be rotated by means of bearings (not shown). The conductors 13b include Al, which has an excellent conductivity and may be subject to a die casting technique. Each permanent magnet 13d is interacted with a magnetic flux generated by the coil 12 so that a torque for driving the LSPM synchronous motor 10 may be generated.

If a current is applied to the coil 12 in the conventional LSPM synchronous motor 10 as described above, the rotational magnetic flux generated due to the structure of the stator 11 is interacted with an induced current generated in the conductors 13b of the rotor 13, so that the rotor 13 may be rotated with respect to the stator 11. If the rotor 13 reaches to a synchronization speed, a torque due to the permanent magnets 13d and a reluctance torque due to the specific structure of the rotor 13 are generated to rotate the rotor 13.

Meanwhile, the rotor 13 in the conventional LSPM synchronous motor 10 has the multiplicity of permanent magnets 13d, wherein the positions of the permanent magnets 13d in the rotor 13, i.e., the distances between the permanent magnets 13d and the conductors 13b, have an effect on the features of the motor such as the output thereof.

However, since the features such as the rotational speed and the torque of the LSPM synchronous motor 10 depend on the respective applications and functions of the product such as an air-conditioner, a washing machine or etc. in which the LSPM synchronous motor 10 is generally used, the LSPM synchronous motor 10 should be manufactured depending on the specification of the product itself, thereby allowing the manufacturing cost of the product to be increased.

As such, a new LSPM synchronous motor continues to be required in that the features such as the rotational speed, the torque, etc. may be easily controlled depending on various products, thereby reducing the manufacturing cost of the product.

### SUMMARY OF THE INVENTION

It is, therefore, an object of the present invention to provide a rotor for use in an LSPM synchronous motor capable of causing permanent magnets to be selectively mounted to a plurality of magnet mounting holes arranged along at least one radial direction of the rotor core, so that the distances between the permanent magnets and conductors may be controlled without changing a specification of the rotor core itself, thereby easily controlling the features such as rotational speeds, torques, etc. of the LSPM synchronous motor and dramatically reducing the manufacturing cost of the LSPM synchronous motor. In accordance with an aspect of the present invention, there is provided a rotor for use in a line start permanent magnet synchronous motor including: a rotor core which has a central portion and a circumferential portion, wherein a shaft hole is formed at the central portion, a plurality of conductor mounting holes are formed along the circumferential portion, a plurality of conductors are inserted into the conductor mounting holes, respectively, and a multiplicity of magnet mounting holes are arranged around the shaft hole along at least one radial direction from the shaft hole; and at least one permanent magnet selectively mounted into at least one corresponding magnet mounting hole.

### BRIEF DESCRIPTION OF THE DRAWINGS

The above and other objects and features of the present invention will become apparent from the following description of preferred embodiments, given in conjunction with the accompanying drawings, in which:

FIG. 1 is a plan view illustrating primary portions of the prior art line start permanent magnet (LSPM) synchronous motor;

FIG. 2 provides an exploded perspective view illustrating a rotor assembly for an LSPM synchronous motor in accordance with a first embodiment of the present invention;

FIG. 3 is a cross sectional view illustrating the rotor assembly for the LSPM synchronous motor in according with the first embodiment of the present invention;

FIG. 4 shows a cross sectional view illustrating a rotor assembly for an LSPM synchronous motor in accordance with a second embodiment of the present invention;

FIG. 5 describes a cross sectional view illustrating a rotor assembly for an LSPM synchronous motor in accordance with a third embodiment of the present invention; and

FIG. 6 represents a cross sectional view illustrating a rotor assembly for an LSPM synchronous motor in accordance with a fourth embodiment of the present invention.

### DETAILED DESCRIPTION OF THE PREFERRED EMBODIMENTS

Hereinafter, preferred embodiments of the present invention will be described in detail with reference to the accompanying drawings so that the present invention may be easily implemented by those skilled in the art. However, it is to be noted that the present invention is not limited to the preferred embodiments but can be varied in various-ways.

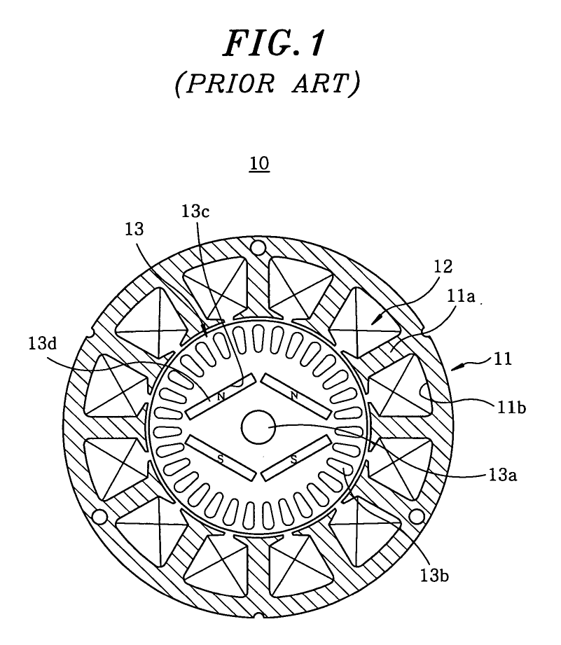

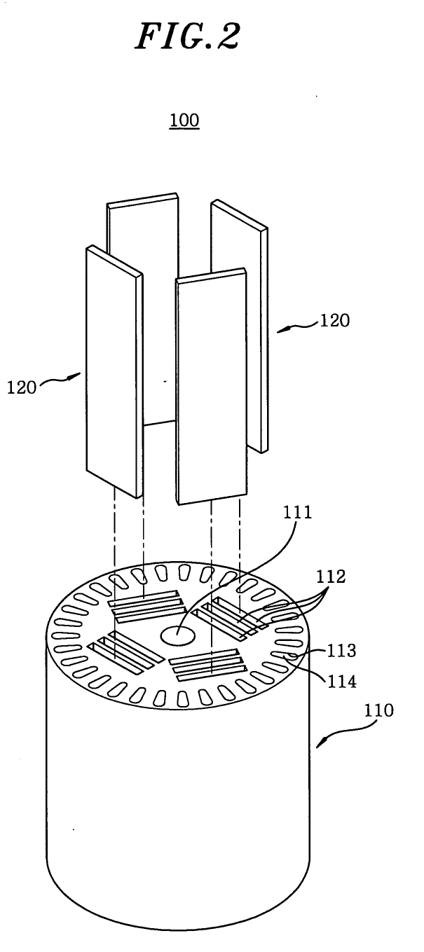

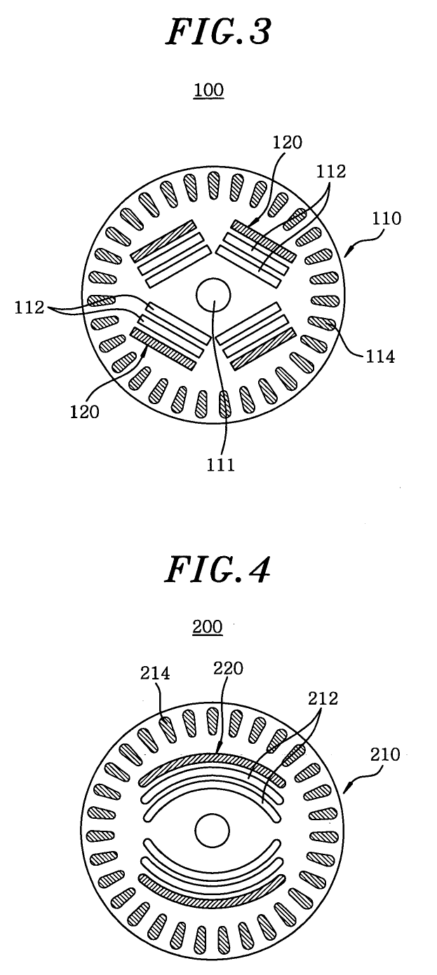

Referring to FIG. 2, there is provided an exploded perspective view illustrating a rotor assembly for use in a line start permanent magnet (LSPM) synchronous motor in accordance with a first embodiment of the present invention; and, referring to FIG. 3, there is provided a cross sectional view illustrating the rotor assembly for use in the LSPM synchronous motor in according with the first embodiment of the present invention. As shown in the drawings, a rotor assembly 100 for use in the LSPM synchronous motor in accordance with the first embodiment of the present invention is installed into the stator 11 (see FIG. 1) with a gap configured between the rotor assembly 100 and the stator 11 so that the rotor assembly 100 may be rotated in the stator 11.

The rotor assembly 100 includes a rotor core 110, which has a central portion and a circumferential portion. A shaft hole 111 is vertically formed at a central portion of the rotor core 110 so that the shaft 13a (see FIG. 1) may be inserted into and fixed to the shaft hole 111. A plurality of conductor inserting holes 113 are formed along a circumferential portion of the rotor core 110, and every two adjacent conductor inserting holes 113 may be equidistantly apart from each other. Preferably, each conductor 114 includes Al, which has an excellent conductivity and may be subject to a die casting technique. One conductor 114 is inserted into and fixed to each conductor inserting hole 113 by means of the die casting technique, etc.

A multiplicity of magnet mounting holes 112 are arranged around the shaft hole 111 along at least one radial direction from the shaft hole 111 of the rotor core 110 in accordance with the present invention, and at least one permanent magnet 120 may be selectively mounted into at least one corresponding magnet mounting hole 112 based on the required features such as the rotational speed, the torque, etc. of the LSPM synchronous motor.

It is preferable that the magnet mounting holes 112 are arranged along 2N radial directions, N being a natural number. The magnet mounting holes 112 arranged along 2N radial directions may be categorized into sub-groups so that 2N magnet mounting holes 112 may be included in each sub-group, and 2N permanent magnets 120 are mounted into said 2N magnet mounting holes 112 included in one of the sub-groups, respectively. Further, the 2N magnet mounting holes 112 included in each sub-group may be positioned at an identical distance from the center of the rotor core 110. It is more preferable that the 2N magnet mounting holes 112 included in each sub-group may be axially symmetric with each other with respect to the shaft hole 111 and the 2N magnet mounting holes 112 may be equidistant from each other.

For example, referring to FIGS. 2 and 3, three magnet mounting holes 112 are sequentially arranged along each radial direction from the shaft hole 111 so that twelve magnet mounting holes are totally arranged along four radial directions, and four permanent magnets 120 are selectively mounted on four corresponding magnetic mounting holes 112. Each magnet mounting hole may have an identical dimension as show in FIGS. 2 and 3.

The rotor core 110 may be formed by a stacking process of a plurality of laminated silicon steel plates or by a compression process for a soft magnetic powder.

In order to manufacture the rotor core 110 by a compression molding process, a molding space which has a shape corresponding to the rotor core 110 is provided in a compression molding apparatus; the molding space is filled with the soft magnetic powder; and an impact-applying member such as a punch is used to compress the soft magnetic powder so that the shaft hole 111, the magnet mounting holes 112 and the conductor inserting holes 113 may be formed concurrently.

The soft magnet powder used to manufacture the rotor core 110 may include iron-based particles which are respectively coated to be electrically isolated from each other. During the compression process, a lubricant and/or a binder may be added to the soft magnet powder, if necessary.

The compression process of the soft magnet powder causes the rotor core 110 to be configured as a soft magnetic composite (SMC) having a three dimensional shape. As such, unlike the conventional rotor core having a stacking structure of laminated silicon steel plates with an identical shape, a higher degree of freedom may be allowed in the rotor core 110 of the present invention so that a number of various shapes may be implemented for the magnet mounting holes 112 as well as the conductor inserting holes 113 in accordance with the present invention.

As shown in FIG. 4, there is provided a cross sectional view illustrating a rotor assembly 200 for an LSPM synchronous motor in accordance with a second embodiment of the present invention. Unlike the magnet mounting holes 112 of the plate shape as shown in FIGS. 2 and 3, the rotor assembly 200 includes a rotor core 210 provided with curve-shaped magnet mounting holes 212, permanent magnets 220 are formed to be inserted to the curve-shaped magnet mounting holes 212.

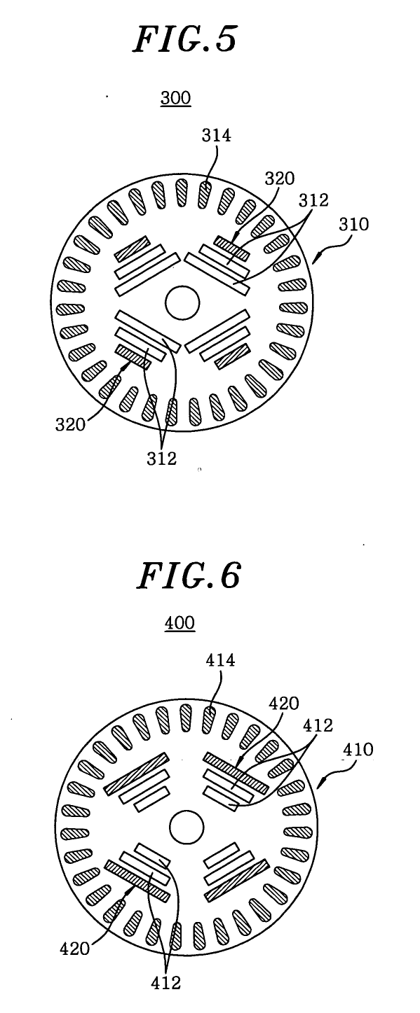

As shown in FIG. 5, there is provided a cross sectional view illustrating a rotor assembly 300 for an LSPM synchronous motor in accordance with a third embodiment of the present invention. The rotor assembly 300 has a rotor core 310 provided with a multiplicity of, e.g., 12, magnet mounting holes 312 arranged along four radial directions. The size of the magnet mounting holes 312 arranged along a specific radial direction gets decreased as the locations of the magnet mounting holes 312 get away from the central portion of the rotor core 310. That is, longer widths and/or shorter widths of the magnet mounting holes 312 get decreased as the positions of the magnet mounting holes 312 approach the circumferential portion of the rotor core 310. As such, since a permanent magnet 320 mounted to each magnet mounting hole 312 is formed with a dimension depending on its mounting position, various features of the LSPM synchronous motor may be realized without replacing the rotor core 310 with other ones. Furthermore, since the size of the permanent magnets 320 gets decreased as the permanent magnets 320 are positioned closer to the conductor side, i.e., closer to the circumferential portion of the rotor core 310, the features of the LSPM synchronous motor may be finely controlled.

As shown in FIG. 6, there is provided a cross sectional view illustrating a rotor assembly 400 for an LSPM synchronous motor in accordance with a fourth embodiment of the present invention. The rotor assembly 400 has a rotor core 410 provided with a multiplicity of, e.g., 12, magnet mounting holes 412 arranged along four radial directions. The size of the magnet mounting holes 412 arranged along a specific radial direction gets increased as the locations of the magnet mounting holes 412 get away from the central portion of the rotor core 410 along the radial direction. That is, longer widths and/or shorter widths of the magnet mounting holes 412 get increased as the positions of the magnet mounting holes 412 approach the circumferential portion of the rotor core 410. As such, since a permanent magnet 420 mounted to each magnet mounting hole 412 is formed with a dimension depending on its mounting position, various features of the LSPM synchronous motor may be realized without replacing the rotor core 410 with other ones. Furthermore, since the size of the permanent magnets 420 gets increased as the permanent magnets 420 are positioned closer to the conductor side, i.e., closer to the circumferential portion of the rotor core 410, the features of the LSPM synchronous motor may be rapidly controlled.

The operation of the rotor of the LSPM synchronous motor as configured above will be described hereinafter in detail.

The permanent magnets 120, 220, 320 and 420 may be selectively mounted into the magnet mounting holes 112, 212, 312 and 412 arranged along the radial directions of the rotor cores 110, 210, 310 and 410, respectively, so that the distances between the permanent magnets 120, 220, 320 and 420 and the conductors 114, 214, 314 and 414 may be adjusted without changing the specifications of the rotor cores 110, 210, 310 and 410, respectively, thereby easily controlling the motor features such as the rotational speed, the torque, etc thereof. For example, if the distances between the permanent magnets 120, 220, 320 and 420 and the conductors 114, 214, 314 and 414 are smaller, the torque may be increased.

If the respective magnet mounting holes 112 and 212 arranged along the radial directions of the respective rotor cores 110 and 210 have an identical dimension with each other as shown in FIGS. 3 and 4, the features of the motor may be easily controlled without changing the specification of the respective permanent magnets 120 and 220 themselves.

If the longer widths and/or the shorter widths of the magnet mounting holes 312 arranged along the radial direction of the rotor core 310 get decreased as the locations of the magnet mounting holes 312 get away from the central position of the rotor core 310 along the radial direction as shown in FIG. 5, the features of the motor may be finely controlled without changing the specification of the rotor core 310.

If the longer widths and/or the shorter widths of the magnet mounting holes 412 arranged along the radial direction of the rotor core 410 get increased as the magnet mounting holes 412 get away from the central position of the rotor core 410 along the radial direction as shown in FIG. 6, the features of the motor may be rapidly changed without changing the specification of the rotor core 410.

As described above in detail, the rotor assembly for use in the LSPM synchronous motor in accordance with the present invention may allows the permanent magnets to be selectively mounted to the magnet mounting holes arranged along the radial directions of the rotor core, so that the distances between the permanent magnets and the conductors may be adjusted without changing the specification of the rotor core itself, thereby easily controlling the features such as rotational speeds, torques, etc. of the LSPM synchronous motor and dramatically reducing the manufacturing cost of the LSPM synchronous motor.

While the invention has been shown and described with respect to the preferred embodiment, it will be understood by those skilled in the art that various changes and modifications may be made without departing from the spirit and scope of the invention as defined in the following claims.

What is claimed is:

1. A rotor for use in a line start permanent magnet synchronous motor, comprising:
a rotor core which has a central portion and a circumferential portion, wherein a shaft hole is formed at the central portion, a plurality of conductor mounting holes are formed along the circumferential portion, a plurality of conductors are inserted into the conductor mounting holes, respectively, and a multiplicity of magnet mounting holes are arranged around the shaft hole along at least one radial direction from the shaft hole; and
at least one permanent magnet selectively mounted into at least one corresponding magnet mounting hole.

2. The rotor of claim 1, wherein the multiplicity of magnet mounting holes are arranged along 2N radial directions, N being a natural number.

3. The rotor of claim 2, wherein the multiplicity of magnet mounting holes arranged along 2N radial directions are categorized into sub-groups so that 2N magnet mounting holes is included in each sub-group, and 2N permanent magnets are mounted into said 2N magnet mounting holes included in one of the sub-groups, respectively.

4. The rotor of claim 3, wherein said 2N magnet mounting holes included in each sub-group are positioned at an identical distance from the center of the rotor core.

5. The rotor of claim 4, wherein said 2N magnet mounting holes included in each sub-group is symmetric with each other with respect to the shaft hole.

6. The rotor of claim 5, wherein said 2N magnet mounting holes included in each sub-group is equidistant from each other.

7. The rotor of claim 1, wherein the magnet mounting holes have an identical dimension.

8. The rotor of claim 1, wherein the magnet mounting holes arranged along said at least one radial direction have a smaller dimension as the magnet mounting holes are positioned farther away from the central portion.

9. The rotor of claim 1, wherein the magnet mounting holes arranged along said at least one radial direction have a larger dimension as the magnet mounting holes are positioned farther away from the central portion.

10. The rotor of claim 1, wherein the rotor core is formed by compressing soft magnet powders.

11. A line start permanent magnet synchronous motor, comprising:
a stator; and
a rotor configured to be rotated in the stator, wherein the rotor includes:
a rotor core which has a central portion and a circumferential portion, wherein a shaft hole is formed at the central portion, a plurality of conductor mounting holes are formed along the circumferential portion, a plurality of conductors are inserted into the conductor mounting holes, respectively, and a multiplicity of magnet mounting holes are arranged around the shaft hole along at least one radial direction from the shaft hole; and
at least one permanent magnet selectively mounted into at least one corresponding magnet mounting hole.

12. The line start permanent magnet synchronous motor of claim 11, wherein the multiplicity of magnet mounting holes are arranged along 2N radial directions, N being a natural number.

13. The line start permanent magnet synchronous motor of claim 12, wherein the multiplicity of magnet mounting holes arranged along 2N radial directions are categorized into sub-groups so that 2N magnet mounting holes may be included in each sub-group, and 2N permanent magnets are mounted into said 2N magnet mounting holes included in one of the sub-groups, respectively.

14. The line start permanent magnet synchronous motor of claim 13, wherein said 2N magnet mounting holes included in each sub-group are positioned at an identical distance from the center of the rotor core.

15. The line start permanent magnet synchronous motor of claim 14, wherein said 2N magnet mounting holes included in each sub-group is symmetric with each other with respect to the shaft hole.

16. The line start permanent magnet synchronous motor of claim 15, wherein said 2N magnet mounting holes included in each sub-group may be equidistant from each other.

17. The line start permanent magnet synchronous motor of claim 11, wherein the magnet mounting holes have an identical dimension.

18. The line start permanent magnet synchronous motor of claim 11, wherein the magnet mounting holes arranged along said at least one radial direction have a smaller dimension as the magnet mounting holes are positioned farther away from the central portion.

19. The line start permanent magnet synchronous motor of claim 11, wherein the magnet mounting holes arranged along said at least one radial direction have a larger dimension as the magnet mounting holes are positioned farther away from the central portion.

20. The line start permanent magnet synchronous motor of claim 11, wherein the rotor core is formed by compressing soft magnet powders.
